(19) United States
(12) Patent Application Publication
(10) Pub. No.: US 2024/0408957 A1
(43) Pub. Date: Dec. 12, 2024

(54) VEHICLE OUTSIDE AIR INTAKE STRUCTURE

(71) Applicant: SUBARU CORPORATION, Tokyo (JP)

(72) Inventor: Ryo INAGAKI, Tokyo (JP)

(21) Appl. No.: 18/637,040

(22) Filed: Apr. 16, 2024

(30) Foreign Application Priority Data
Jun. 7, 2023 (JP) 2023-094157

(51) Int. Cl. B60K 11/08; B60K 11/04; B60R 5/02; H01M 10/613; H01M 10/625; H01M 10/6563

(52) U.S. Cl. CPC B60K 11/08; B60K 11/04; B60R 5/02; H01M 10/613; H01M 10/625; H01M 10/6563; H01M 2220/20

(57) ABSTRACT

A vehicle outside air intake structure configured to supply an outside air to an in-vehicle battery to be stored in an underfloor space of a vehicle body of a vehicle includes: an outside air intake port at a front part of the vehicle body; a front trunk in a chamber of the vehicle body; an opening-and-closing lid configured to block an upper surface opening of the front trunk so as to be openable; a first air passage communicating with the outside air intake port, and provided between a front hood of the vehicle body and the opening-and-closing lid; and a second air passage communicating with both of the first air passage and the underfloor space, and provided rearward of the front trunk. The outside air introduced from the outside air intake port is to be blown through the first air passage and the second air passage into the underfloor space.

### CROSS-REFERENCE TO RELATED APPLICATIONS

The present application claims priority from Japanese Patent Application No. 2023-094157 filed on Jun. 7, 2023, the entire contents of which are hereby incorporated by reference.

### BACKGROUND

The disclosure relates to a vehicle outside air intake structure.

As a cooling structure for a battery for an electric vehicle up to now, for example, the structure disclosed in Japanese Unexamined Patent Application Publication (JP-A) No. H5-193376 has been known.

An electric vehicle is provided with front wheels, rear wheels, and a vehicle body. As frame members included in the vehicle body, the electric vehicle is provided with a pair of side frames, and a front side cross member and a rear side cross member that are coupled to the side frames. Further, the side frames support a battery box being hung between the front wheels and the rear wheels.

The battery box is provided with a box main body that stores batteries for driving an electric vehicle. Further, a suction passage member for sucking a cooling air into the box main body is formed at a front part side of the vehicle in the box main body. The suction passage member opens at an upper end side, and includes an opening for sucking a cooling air into the box main body. Moreover, the box main body has a hole for discharging a cooling air at a rear side of the vehicle. Further, a cooling fan is disposed in the hole.

### SUMMARY

An aspect of the disclosure provides a vehicle outside air intake structure configured to supply an outside air to an in-vehicle battery stored in an underfloor space of a vehicle body of a vehicle. The vehicle outside air intake structure includes an outside air intake port, a front trunk, an opening-and-closing lid, a first air passage, and a second air passage. The outside air intake port is disposed at a front part of the vehicle body. The front trunk is disposed in a chamber of the vehicle body. The opening-and-closing lid configured to block an upper surface opening of the front trunk so as to be openable. The first air passage communicates with the outside air intake port, and is provided between a front hood of the vehicle body and the opening-and-closing lid. The second air passage communicates with both of the first air passage and the underfloor space, and is provided rearward of the front trunk. The outside air introduced from the outside air intake port is to be blown through the first air passage and the second air passage into the underfloor space.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1A is a cross-sectional view illustrating a vehicle including a vehicle outside air intake structure according to an embodiment of the disclosure.

FIG. 1B is a cross-sectional view illustrating the vehicle including the vehicle outside air intake structure according to the embodiment of the disclosure.

FIG. 2 is a cross-sectional view illustrating the vehicle outside air intake structure according to the embodiment of the disclosure.

FIG. 3A is a top view illustrating the vehicle outside air intake structure according to the embodiment of the disclosure.

FIG. 3B is a cross-sectional view illustrating the vehicle outside air intake structure according to the embodiment of the disclosure.

FIG. 4 is a cross-sectional view illustrating the vehicle including the vehicle outside air intake structure according to the embodiment of the disclosure.

### DETAILED DESCRIPTION

In a battery box, cooling fan operates when a battery stored in a box main body is cooled. Further, cooling air is sucked from an opening of a suction passage member into the box main body. The sucked cooling air flows through the box main body, and is discharged from a hole to the outside of the box main body.

Meanwhile, in an electric vehicle, a power unit is downsized because an engine is replaced with a motor, so that it is possible to use a chamber at the front part of the vehicle body as a storage space. However, the chamber is positioned directly below the front hood, there is a problem in that the temperature in the chamber becomes high due to an influence by solar radiation and the like, and baggage stored in the chamber becomes worse. Moreover, in order to use a part of the chamber as a battery cooling air passage for supplying a cold blast to the battery box, a reasonable layout in relation to the storage space is desired.

The disclosure is made in view of the circumstances, and relates to a vehicle outside air intake structure configured to use a chamber at a front part of a vehicle body as a storage space and a battery cooling air passage in a reasonable layout, and prevent the temperature in the storage space from increasing by solar radiation and the like.

Hereinafter, a vehicle outside air intake structure 10 according to an embodiment of the disclosure will be described in detail based on the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Moreover, the front-rear direction of the paper indicates a total length direction of a vehicle 11, the left-right direction of the paper indicates a vehicle width direction of the vehicle 11, and the up-down direction of the paper indicates a height direction of the vehicle 11.

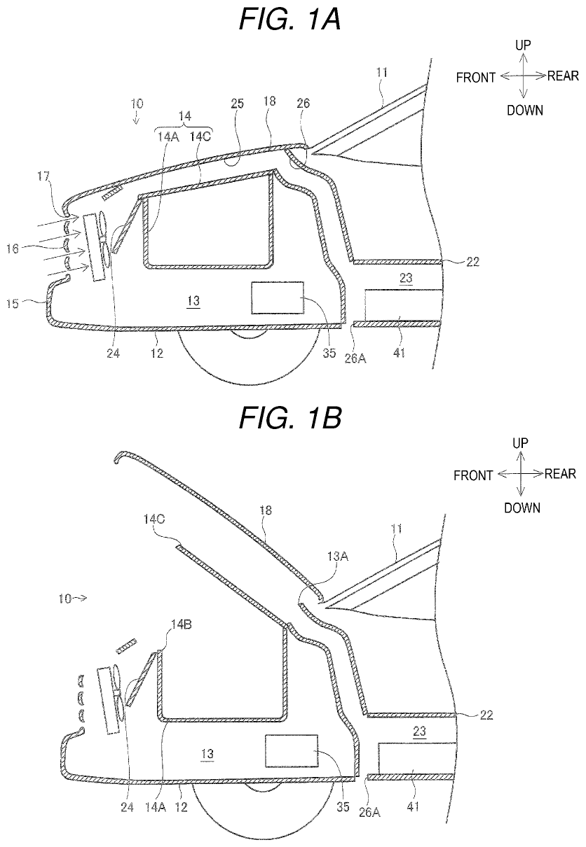

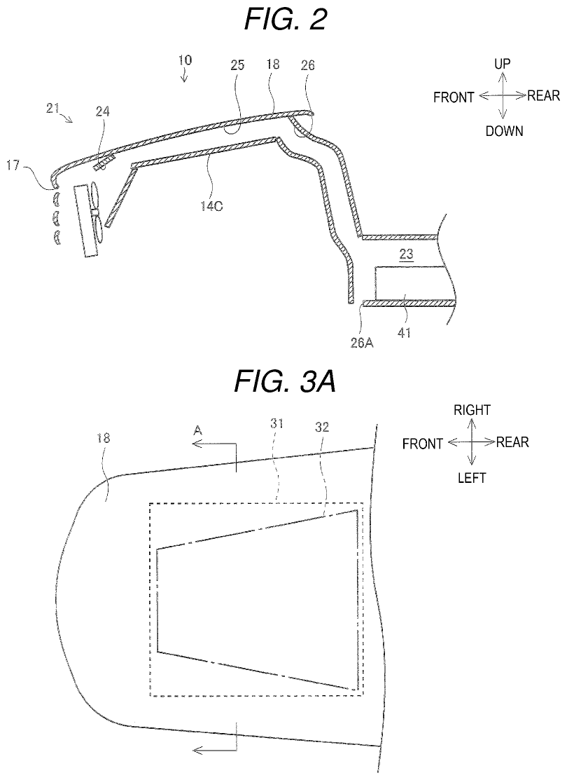

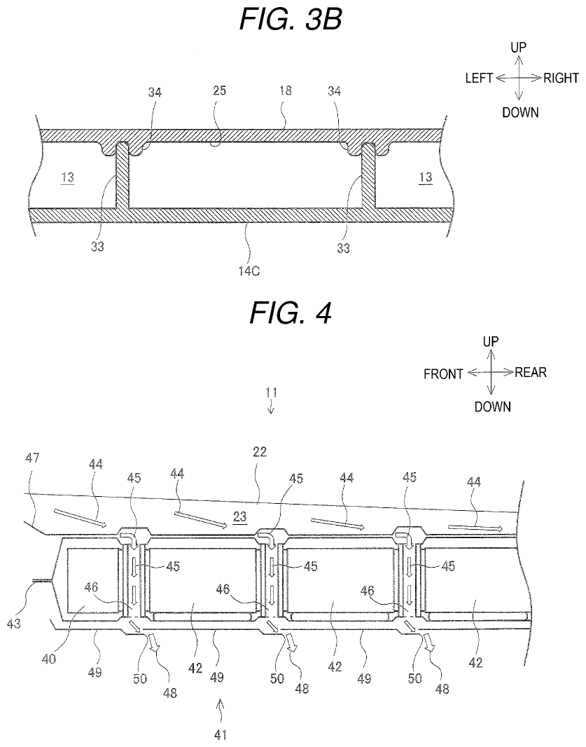

FIG. 1A and FIG. 1B are cross-sectional views illustrating the vehicle 11 to which the vehicle outside air intake structure 10 in the present embodiment is disposed. FIG. 2 is a cross-sectional view illustrating the vehicle outside air intake structure 10 in the present embodiment. FIG. 3A is a top view illustrating a first air passage 25 in the vehicle outside air intake structure 10 in the present embodiment. FIG. 3B is a cross-sectional view illustrating the first air passage 25 of the vehicle outside air intake structure 10 in the present embodiment, and illustrates a cross section in an A-A line direction illustrated in FIG. 3A. FIG. 4 is a cross-sectional view illustrating an underfloor space 23 of the vehicle 11 in which the vehicle outside air intake structure 10 in the present embodiment is disposed. Note that, FIG. 1A to FIG. 2 schematically illustrate a structure of a vehicle body 12, for convenience of the description.

As illustrated in FIG. 1A and FIG. 1B, for example, a battery electrical vehicle (BEV), a hybrid electrical vehicle (HEV), a plug-in hybrid electrical vehicle (PHEV), or the like is employed as the vehicle 11.

When the vehicle 11 is BEV, for example, engine components are not used, and a front trunk 14 is thus disposed in a chamber 13 that is a front storage space at a front part of the vehicle body 12. The front trunk 14 is a storage space in which baggage is mainly stored. The front trunk 14 is provided with a main body 14A including the storage space, and an opening-and-closing lid 14C that blocks an upper surface opening 14B of the main body 14A so as to be openable.

A front bumper 15, a front grille 16, and an outside air intake port 17 are formed at the front part of the vehicle body 12. The outside air intake port 17 is, for example, an opening for introducing the outside air into the chamber 13 when the vehicle 11 is traveling. Further, the front grille 16 is assembled to a formation region of the outside air intake port 17 of the vehicle body 12, above the front bumper 15.

In an upper part of the chamber 13 in the vehicle body 12, a front hood 18 that blocks an upper surface opening 13A of the chamber 13 so as to be openable is assembled to the front part of the vehicle body 12. As illustrated in FIG. 1B, the front hood 18 and the opening-and-closing lid 14C of the front trunk 14 are separately assembled to the vehicle body 12. With this structure, in no collaboration with an opening and closing motion of the front hood 18, an opening and closing motion of the opening-and-closing lid 14C is individually performed independent of the front hood 18.

A radiator 19 and an air blowing fan 20 are disposed in the chamber 13 of the vehicle body 12 and rearward of the outside air intake port 17. The outside air introduced from the outside air intake port 17 into the chamber 13 is passed through the radiator 19 and the air blowing fan 20, and is then blown to an outside air introduction air passage 24, which is described later. Note that, when the outside air introduction air passage 24, which is described later, is formed continuous with the outside air intake port 17, the radiator 19 and the air blowing fan 20 may be disposed to the outside air introduction air passage 24.

Moreover, the air blowing fan 20 is disposed in the vicinity of the radiator 19, operates when the vehicle 11 is stopped or the vehicle 11 is travelling at the low speed, and introduces an outside air from the outside air intake port 17 into the chamber 13.

Next, as illustrated in FIG. 1A and FIG. 2, in the present embodiment, the vehicle outside air intake structure 10 is formed at the front part of the vehicle body 12. The vehicle outside air intake structure 10 mainly includes the outside air intake port 17, and an outside air blowing air passage 21 that communicates with the outside air intake port 17 and blows the outside air introduced from the outside air intake port 17 into the underfloor space 23. In other words, the outside air blowing air passage 21 is, for example, an air passage for blowing the outside air introduced from the outside air intake port 17 into the underfloor space 23 below a floor panel 22 of the vehicle body 12.

The outside air blowing air passage 21 includes, for example, the outside air introduction air passage 24, the first air passage 25 that communicates with the outside air introduction air passage 24, and a second air passage 26 that communicates with each of the first air passage 25 and the underfloor space 23.

The outside air introduction air passage 24 is formed by extrusion using a synthetic resin plate having a multilayer structure, for example. The outside air introduction air passage 24 is assembled to the vehicle body 12 in front of the front trunk 14. The outside air introduction air passage 24 is an air passage for blowing the outside air introduced from the outside air intake port 17 into the chamber 13, into the first air passage 25.

Note that, the outside air in the present embodiment is an air present outside the vehicle 11, and indicates a travel wind that is introduced from the outside air intake port 17 into the chamber 13 when the vehicle 11 is travelling or a wind that is sucked from the outside air intake port 17 into the chamber 13 because the air blowing fan 20 operates when the vehicle 11 is stopped or is travelling at the low speed, for example.

The first air passage 25 is formed using the opening-and-closing lid 14C of the front trunk 14 and the front hood 18, for example, and is formed between the opening-and-closing lid 14C and the front hood 18. Although details are described later, in a state where the opening-and-closing lid 14C is fully opened relative to the main body 14A of the front trunk 14, the front hood 18 is fully closed relative to the chamber 13 of the vehicle body 12 to form the first air passage 25. On the other hand, the front hood 18 is opened relative to the chamber 13 of the vehicle body 12, so that the first air passage 25 becomes in an open state and temporarily disappears.

The second air passage 26 is formed by extrusion using a synthetic resin plate having a multilayer structure, for example. The second air passage 26 is assembled to the vehicle body 12 rearward of the front trunk 14. As illustrated, the second air passage 26 is disposed so as to extend in a height direction of the vehicle body 12, and causes the first air passage 25 that is positioned above the front trunk 14 with the underfloor space 23 that is positioned below the front trunk 14 to communicate with each other.

With this structure, the outside air flowing through the first air passage 25 flows between the opening-and-closing lid 14C of the front trunk 14 and the front hood 18. The outside air flowing through the first air passage 25 performs heat exchange with the opening-and-closing lid 14C, thereby preventing the inside of the front trunk 14 from becoming an overheat state. Moreover, an air layer by the first air passage 25 is formed between the opening-and-closing lid 14C and the front hood 18 to make heat to be generated due to the direct sunlight to the front hood 18 difficult to transfer to the front trunk 14.

As a result, in the front trunk 14, the heat that is transferred from the front hood 18 and the heat that is transferred from a motor and the like disposed in the vicinity of the front trunk 14 are radiated by the outside air flowing through the first air passage 25. Further, an increase in the temperature in an internal space of the front trunk 14 is prevented, and the baggage stored in the front trunk 14 is prevented from being damaged due to the high heat.

Moreover, the outside air to be blown to the underfloor space 23 is introduced from the outside air intake port 17 above the front bumper 15, so that, for example, when the vehicle is travelling in the rainy weather or is traveling on a flooded road, water is difficult to permeate from the outside air intake port 17 into the chamber 13 and the outside air blowing air passage 21. Further, water is difficult to be contained in the outside air to be blown to the underfloor space 23 to prevent an in-vehicle battery stored in the underfloor space 23 from malfunctioning, shorting out, for example. Note that, the second air passage 26 has a drainage hole 26A in an upstream corner in a coupling location with the underfloor space 23. Further, when the outside air flowing inside the second air passage 26 collides with the corner part, the water contained in the outside air is discharged from the drainage hole 26A to the outside of the vehicle.

Next, FIG. 3A illustrates a state in which the front hood 18 is seen from a design surface side, a dotted line 31 illustrates the opening-and-closing lid 14C of the front trunk 14, and a dash-dotted line 32 illustrates the first air passage 25. As illustrated, the first air passage 25 includes an air passage width that becomes wider from the outside air intake port 17 toward the second air passage 26 side. Further, although the illustration is omitted, the underfloor space 23 spreads over an approximate entire surface below the floor panel 22 in a vehicle cabin.

With this structure, the outside air flowing through the outside air blowing air passage 21 is blown as homogeneously as possible from the second air passage 26 to the underfloor space 23. Further, the outside air is supplied to an in-vehicle battery 41 stored in the underfloor space 23 as homogeneously as possible to prevent a battery cell 42 of the in-vehicle battery 41 from locally becoming an overheat state and the in-vehicle battery 41 from malfunctioning.

As illustrated in FIG. 3B, a pair of air passage walls 33 extending in the total length direction of the vehicle 11 is formed on an upper surface of the opening-and-closing lid 14C of the front trunk 14. The air passage walls 33 are permanently affixed to the opening-and-closing lid 14C, for example. Further, the air passage walls 33 that repeatedly collide with fitting parts 34 of the front hood 18 every time when the front hood 18 performs the opening and closing motion have a plate thickness with a desired strength.

Meanwhile, a pair of the fitting parts 34 extending in the total length direction of the vehicle 11 is formed on a lower surface of the front hood 18. As mentioned above, in a state where the opening-and-closing lid 14C is fully closed relative to the main body 14A of the front trunk 14, the front hood 18 is fully closed relative to the chamber 13 of the vehicle body 12 to insert distal sides of the air passage walls 33 into the fitting parts 34 respectively, so that both of the members become in a fitting state.

With this structure, the first air passage 25 is defined as a space, in the chamber 13, surrounded by the front hood 18, the opening-and-closing lid 14C, the air passage walls 33, and the fitting parts 34. Note that, the present embodiment is not limited to the air passage walls 33 formed on the opening-and-closing lid 14C, and the fitting parts 34 formed on the front hood 18. For example, the air passage walls 33 may be formed on the front hood 18, and the fitting parts 34 may be formed on the opening-and-closing lid 14C. In addition, any design change is possible as long as the structure includes the first air passage 25 when the opening-and-closing lid 14C and the front hood 18 are in fully closed states.

Moreover, in the vicinity of the front trunk 14 of the chamber 13, an electricity supply unit (ESU) 35 (see FIG. 1A) is disposed. Further, there is a room for improvement in that the inside of the front trunk 14 may be heated by the heat and the like to be generated from the ESU 35. Moreover, there is a room for improvement in that the inside of the front trunk 14 may be heated by the heat and the like to be generated due to direct sunlight to the front hood 18.

Therefore, in the present embodiment, the opening-and-closing lid 14C of the front trunk 14 is in contact with the outside air flowing through the first air passage 25, performs heat exchange therewith, thereby preventing the inside of the front trunk 14 from becoming an overheat state.

As illustrated in FIG. 4, the underfloor space 23 is formed below an occupant boarding space of the vehicle 11, and below the floor panel 22 of the vehicle body 12. Further, the in-vehicle battery 41 that supplies electric power to the motor of the vehicle 11 and various electrical components is stored in the underfloor space 23. In the in-vehicle battery 41, for example, battery cells 42 are serially coupled and stored in a battery case 43. Note that, in the underfloor space 23, a battery control unit (BCU) that is electronic equipment and a junction box 40 are disposed, and are electrically coupled to the in-vehicle battery 41. Note that, as the battery cell 42, for example, secondary batteries such as a nickel hydrogen battery and a lithium ion battery, and an all-solid battery are used.

As illustrated, the battery cells 42 are disposed with a gap 46 having a fixed interval in a longitudinal direction of the in-vehicle battery 41 via a separator. Further, as indicated by arrows 44, the outside air blowing from the second air passage 26 into the underfloor space 23 flows through an air passage between a fixed frame 47 of the battery case 43 and the floor panel 22.

As indicated by arrows 45, part of the outside air blowing into the underfloor space 23 is blown into an inside of the battery case 43 via an introduction opening (not illustrated) provided to the fixed frame 47. Further, the outside air blown into the inside of the battery case 43 performs heat exchange with each battery cell 42 when flowing through the gap 46. Thereafter, as indicated by arrows 48, the outside air that has cooled each battery cell 42 is discharged to the outside of the vehicle from a discharge opening 50 formed in an undercover 49 of the vehicle body 12.

Note that, the present embodiment is not limited to the outside air blowing air passage 21 having the outside air introduction air passage 24. For example, the outside air introduction air passage 24 is not disposed, but an introduction opening (not illustrated) may be provided to a distal end of the first air passage 25. When the introduction opening is provided, part of the outside air introduced from the outside air intake port 17 into the chamber 13 is blown from the introduce opening into the first air passage 25, whereby an effect similar to the abovementioned effect can be obtained. In addition, various modifications can be made without departing from the spirit of the disclosure.

In a vehicle outside air intake structure that is one embodiment of the disclosure, an outside air introduced from an outside air intake port at a front part of a vehicle body is supplied through first and second air passages as battery cooling air passages into an underfloor space in which an in-vehicle battery is stored. Further, a chamber at the front part of the vehicle body is used as a storage space, and the first and second air passages are disposed above the storage space. With this structure, the battery cooling air passages and the storage space are disposed in the chamber in a reasonable layout, and the temperature in the storage space is prevented from increasing due to solar radiation and the like by the outside air and the like flowing through the battery cooling air passages. Further, baggage in the storage space is prevented from being damaged by the high heat.

1. A vehicle outside air intake structure configured to supply an outside air to an in-vehicle battery stored in an underfloor space of a vehicle body of a vehicle, the vehicle outside air intake structure comprising:
an outside air intake port disposed at a front part of the vehicle body;
a front trunk disposed in a chamber of the vehicle body;
an opening-and-closing lid configured to block an upper surface opening of the front trunk so as to be openable;
a first air passage communicating with the outside air intake port, the first air passage being provided between a front hood of the vehicle body and the opening-and-closing lid; and
a second air passage communicating with both of the first air passage and the underfloor space, the second air passage being provided rearward of the front trunk, wherein
the outside air introduced from the outside air intake port is to be blown through the first air passage and the second air passage into the underfloor space.

2. The vehicle outside air intake structure according to claim 1, wherein the opening-and-closing lid is configured to perform an opening and closing motion independent of the front hood.

3. The vehicle outside air intake structure according to claim 2, wherein an air passage wall provided on an upper surface of the opening-and-closing lid is fitted into a fitting part provided on a lower surface of the front hood to form the first air passage.

4. The vehicle outside air intake structure according to claim 3, wherein an air passage width of the first air passage becomes wider from the outside air intake port toward the second air passage side.

5. The vehicle outside air intake structure according to claim 1, wherein
a radiator is disposed rearward of the outside air intake port of the vehicle body, and an air blowing fan is disposed rearward of the radiator, and
the outside air introduced from the outside air intake port is to be blown by the air blowing fan through the first air passage and the second air passage into the underfloor space.

6. The vehicle outside air intake structure according to claim 2, wherein
a radiator is disposed rearward of the outside air intake port of the vehicle body, and an air blowing fan is disposed rearward of the radiator, and
the outside air introduced from the outside air intake port is to be blown by the air blowing fan through the first air passage and the second air passage into the underfloor space.

7. The vehicle outside air intake structure according to claim 3, wherein
a radiator is disposed rearward of the outside air intake port of the vehicle body, and an air blowing fan is disposed rearward of the radiator, and
the outside air introduced from the outside air intake port is to be blown by the air blowing fan through the first air passage and the second air passage into the underfloor space.

8. The vehicle outside air intake structure according to claim 4, wherein
a radiator is disposed rearward of the outside air intake port of the vehicle body, and an air blowing fan is disposed rearward of the radiator, and
the outside air introduced from the outside air intake port is to be blown by the air blowing fan through the first air passage and the second air passage into the underfloor space.
